(19) United States
(12) Patent Application Publication
(10) Pub. No.: US 2023/0252409 A1
(43) Pub. Date: Aug. 10, 2023

(54) STORE DELIVERY VISION SYSTEM

(71) Applicant: Rehrig Pacific Company, Los Angeles, CA (US)

(72) Inventors: Robert Lee Martin, JR., Lucas, TX (US); Justin Corless, Flower Mound, TX (US); Daniel James Thyer, Charlotte, NC (US)

(21) Appl. No.: 18/107,961

(22) Filed: Feb. 9, 2023

Related U.S. Application Data
(60) Provisional application No. 63/308,357, filed on Feb. 9, 2022.

(51) Int. Cl. G06Q 10/087; B62B 5/00; B62B 3/06; G06V 10/10

(52) U.S. Cl. CPC G06Q 10/087; B62B 5/0096; B62B 3/0612; G06V 10/19

(57) ABSTRACT

A pallet sled includes a pair of tines extending forward from a base. A camera is mounted on the pallet sled and is configured to record images, such as video, as the pallet sled brings pallets of items from a truck into a store. At least one processor is used to analyze the images from the pallet sled. The images are used to determine inventory levels in the store, conditions of the store, conditions of the pathways of the pallet sled. An accelerometer on the pallet sled detects hard braking and accidents.

### BACKGROUND

Many items are delivered to stores on pallets. A plurality of loaded pallets may be loaded onto a truck. One or more of the pallets may be destined for each of a plurality of stores. At each store, the driver uses a pallet sled (which may be a pallet jack or the like) to lift one or more pallets and bring them into the store. In the store, the pallets are unloaded and the items placed on store shelves. The empty pallets are then returned to the truck on the pallet sled.

### SUMMARY

A delivery system includes a pallet sled including a pair of tines extending forward from a base and a load wheel supporting each of the pair of tines. The load wheels are each configured to move away from the respective tine to lift the respective tine upward relative to a floor. A camera is mounted on the pallet sled. At least one computer is configured to receive images from the camera. The at least one computer is programmed to analyze the images received from the camera.

In one example, the at least one computer is programmed to identify SKUs of products in the images received from the camera.

In another example, the at least one computer is programmed to determine an inventory level of the products in the images.

The at least one computer may be programmed to determine the inventory level of the products on shelves in the images.

The at least one computer may be programmed to analyze pathways traveled by the pallet sled in the images received from the camera.

The at least one computer may be programmed to determine a condition of a store based upon the images received from the camera.

The at least one computer may be programmed to determine a cleanliness level of the store based upon the images received from the camera.

A pallet sled includes a base, a pair of tines extending forward from the base, and a load wheel supporting each of the pair of tines. The load wheels are each configured to move away from the respective tine to lift the respective tine upward relative to a support surface on which the load wheel is supported. In one embodiment, an accelerometer is mounted to the pallet sled.

A camera may also be mounted to the pallet sled. At least one processor is programmed to record signals from the accelerometer and images from the camera.

The at least one processor may be programmed to record images from the camera based upon the signals from the accelerometer.

The at least one processor may be programmed to record images from the camera based upon the signals from the accelerometer exceeding a threshold.

The at least one processor may be programmed to synchronize images from the camera with the signals from the accelerometer.

The images may be still images, video images, or both.

A method for monitoring operation of a pallet sled includes receiving images from a pallet sled while the pallet sled is delivery items to a store and analyzing the images with at least one processor.

The method may further include identifying SKUs of products in the images.

The method may further include determining an inventory level of the products in the images.

The method may further include determining an inventory level of products on shelves in the images.

The method may further include analyzing pathways traveled by the pallet sled in the images.

The method may further include determining a condition of a store based upon the analysis of the images in step b).

The method may further include using at least one machine learning model to perform the analysis.

### BRIEF DESCRIPTION OF THE DRAWINGS

FIG. 1 is a schematic view of a delivery system.

FIG. 2 is a schematic of the pallet sled of FIG. 1 according to one embodiment.

FIG. 3 shows the pallet sled of FIG. 2 near shelves containing products.

FIG. 4A is a perspective view of the pallet sled of FIG. 2.

FIG. 4B is a perspective view of the underside of the pallet sled of FIG. 1.

FIG. 5 shows the pallet sled of FIG. 1 with the tines in the spaced apart position.

FIG. 6 shows one of the tines of the pallet sled of FIG. 4A, partially broken away.

FIG. 7 shows the tine of FIG. 6 raised to the lift position.

FIG. 8 shows the tine of FIG. 6 in the side shifting position.

FIG. 9 shows an example display screen on the server of FIG. 1.

### DETAILED DESCRIPTION

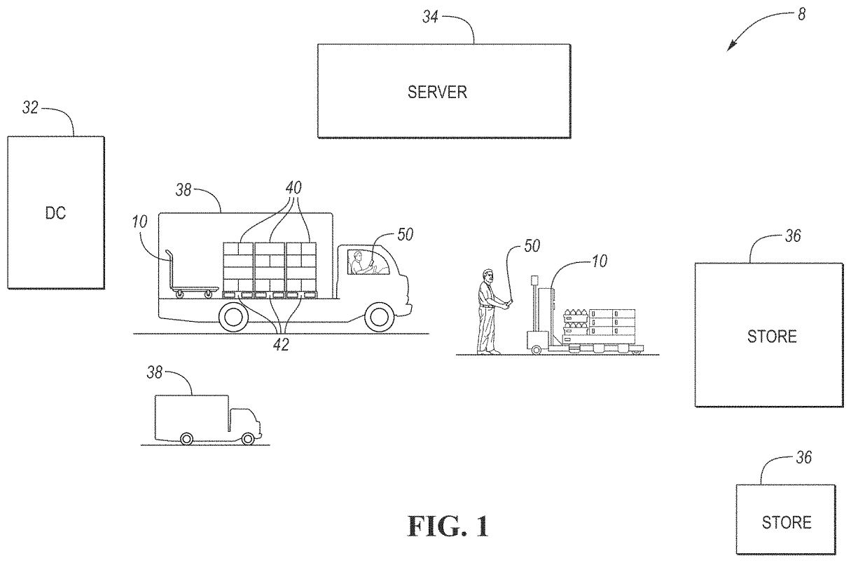

FIG. 1 is a high-level view of a delivery system 8 including one or more distribution centers 32, a central server 34 (e.g. cloud computer), and a plurality of stores 36. A plurality of trucks 38 or other delivery vehicles each transport a plurality of the items 40 on pallets 42 from one of the distribution centers 32 to a plurality of stores 36. A wheeled pallet sled 10 is on each truck 38 to facilitate delivery of one of more pallets 42 of items 40 from the truck 38 to each store 36.

At each store 36 the driver's mobile device 50 indicates which of the loaded pallets 42 (based upon their pallet ids) are to be delivered to that store 36 as verified by gps on the mobile device 50. An app on the mobile device 50 identifies the store 36 where the truck 38 is currently located and looks up which pallets 42 are to be delivered to that store 36. The mobile device 50 may have a list stored internally indicating which pallets 42 are intended for each store 36, or the mobile device 50 may retrieve that information from the server 34 via a wireless network.

While the truck 38 is at the store 36 (e.g. behind the store or in the parking lot), the driver finds the correct pallet(s) 42 for that store 36 in the truck 38. The driver verifies the correct pallet(s) 42 by reading the pallet id (a unique rfid, barcode, etc on each pallet 42) with the mobile device 50. The driver moves one or more of the loaded pallets 42 into the store 36 at a time with the pallet sled 10.

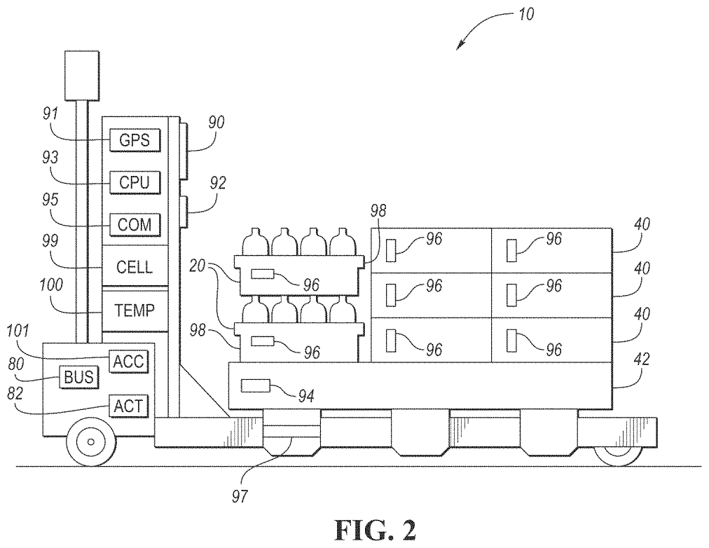

FIG. 2 is a schematic of the pallet sled 10. The pallet sled 10 can include an identification reader, such as an rfid reader 90, configured to check the pallet identification of pallet 42 carried thereon by reading the identification tag, such as rfid tag 94, secured to the pallet 42. The pallet 42 may be a half pallet as shown or a full pallet. The rfid reader 90 may also read rfid tags 96 on the items 40 (if so provided). The rfid reader 90 and rfid tag 94 can be active, passive or a mixture of any radio frequency identification systems. Alternatively, the identification reader and identification tag could utilize other electromagnetic signals to provide a pallet id from the id tag to the id reader, such as optical, including bar codes, qr codes, or the like.

The pallet sled 10 may also accommodate more than one pallet 42 at a time, in which case the rfid tags 94 on each pallet 42 are both read by the rfid reader 90 while the pallets 42 are on the tines of the pallet sled 10.

Optionally the pallet sled 10 may include a camera 92 for imaging the loaded pallet 42 carried thereon for validation. In the configuration shown, the camera 92 would image the short side of the loaded pallet 42 (and the top of the loaded pallet 42). Optionally, the pallet sled 10 includes a plurality of cameras.

A GPS receiver 91 (“GPS” referring generically to any global navigation satellite system) or other location-determining device may be mounted to the pallet sled 10. A CPU 93 (with associated memory, storage, at least one processor, suitable programming, etc and optionally a touch screen and keyboard and mouse) can also be mounted to the pallet sled 10 and is connected to the other devices on the pallet sled 10.

A local wireless communication circuit 95 (e.g. Bluetooth) is also connected to the CPU 93. The communication circuit 95 may communicate the pallet id of the pallet 42 on the pallet sled 10 to the driver's mobile device 50 and/or to the CPU 93. A weight sensor 97 may be integrated into the pallet sled 10 configured to measure weight on the tines to provide a weight of the loaded pallet 42 to the CPU 93 and/or mobile device 50.

A cell data circuit 99 could also be included on the pallet sled 10 and could be used to communicate directly with the central server 34 (FIG. 1), including sending and receiving data and commands. Alternatively, the local communication circuit 95 could provide that same communication by accessing the cell data circuit on the driver's mobile device 50 (e.g. “tethering”).

The pallet sled 10 could also include a temperature sensor 100. The temperature sensor 100 could monitor ambient air temperature or specifically a temperature of a battery that powers the pallet sled 10. Optionally, two temperature sensors could monitor both ambient air and battery temperature. The temperature sensor(s) 100 report measured temperature to the CPU 93 when polled or periodically.

Optionally, an accelerometer 101, such as a three-axis accelerometer 101 may be included on the pallet sled 10. Again, the accelerometer 101 may be incorporated into a mobile device with much if not all of the rest of the hardware.

Much of the hardware on the pallet sled 10 including the CPU 93, GPS receiver 91, camera 92, communication circuit 95, and cell data circuit 99 could all be provided in the form of a mobile device (e.g. smartphone or tablet) mounted to the pallet sled 10. The CPU 93 is connected to all of the hardware and sensors on the sled 10. The CPU 93 also controls actuation of the tines, as directed by the user. For example, the CPU 93 controls the actuator for lifting the tines and, optionally, an actuator for adjusting the tines toward one another.

Optionally, all data is stored locally on CPU 93 and retrieved by a computer at the DC 32 via the local communication circuit 95 whenever the pallet sled 10 returns to the DC 32. The CPU 93 processes event triggers, such as delivery of a pallet 42. Alternatively, the data is sent directly to the server 34 by the CPU 93 via the communication circuit 95.

The pallet sled 10 may also include a bus 80 (such as a CAN BUS) connecting the CPU 93 (or a dedicated vehicle CPU) to multiple sensors and actuators 82, such as a brake actuator and a lift actuator for lifting the tines 14. The sensors may provide data on the bus 80. The actuators 82 may receive commands on the bus 80 and may report errors or faults on the bus 80.

In use, at each store 36, the driver selects one or more of the loaded pallets 42 intended for that store 36 and loads it on the pallet sled 10 in the truck 38. The CPU 93 receives a signal on the bus 80 from one of the actuators 82 (such as the tine lift actuator) indicating that the pallet sled 10 is lifting one or more pallets 42. In response to this signal, the CPU 93 causes the RFID reader 90 to read the pallet ids of the pallet(s) 42 on the pallet sled 10. The CPU 93 may also cause the RFID reader 90 to read the pallet ids based upon a signal on the bus 80 indicating that the pallet sled 10 has been run for a period of time in excess of a threshold.

Based upon reading the rfid tag 94 on the pallet 42 and the current location from the gps receiver 91, the pallet sled 10 determines whether the pallet 42 on the pallet sled 10 is assigned to the store 36 at the current location by accessing information from the server 34 from locally stored list associating pallet ids and stores 36. The pallet sled 10 may indicate a correct pallet 42 or an incorrect pallet 42 with a display (or other visual indicator) and/or sound on the pallet sled 10 and/or a notification sent to the driver's mobile device 50.

Pallet Load Verification

The camera 92 on the pallet sled 10 may take one or more images and send them to the server 34. The server 34 analyzes the image(s) to confirm the presence of the correct number of items 40 of each of the SKUs associated with the pallet id of that pallet 42, and then communicates a confirmation to the pallet sled 10, the driver's mobile device 50 and/or the store employee's mobile device, which is displayed on the screens. The server 34 may use machine learning or other image analysis techniques to identify the SKUs on the pallet 42.

If the pallet sled 10 only images the short side of the loaded pallet 42, then a complete validation of the items 40 on the loaded pallet 42 cannot be done, but it can be a sufficient confirmation that the items 40 on the loaded pallet 42 have not been disturbed since leaving the distribution center, especially if the loaded pallet 42 is wrapped and especially again if the loaded pallet 42 has the right weight.

As another example, the CPU 93 may indicate that the image(s) of the pallet(s) 42 on the pallet sled 10 differ sufficiently from previous image(s) of the pallet(s) 42. An image of each of the four sides of each loaded pallet 42 is taken at the DC 32 for validation. Those images can be used for comparison on the pallet sled 10. The pallet sled 10 CPU 93 knows which loaded pallet 42 it is carrying so those previous images of that loaded pallet 42 are retrieved from the server 34. Those previous images of the loaded pallet 42 are compared to the image(s) taken by the camera 92 on the pallet sled 10. For example, the camera 92 on the pallet sled 10 might only obtain one short-side image of the loaded pallet 42. The CPU 93 compares that one short-side image to the previous short-side images taken at the DC 32. If the image from the camera 92 is not sufficiently similar to either one of the short-side images taken at the DC 32, then the CPU 93 generates a warning to the driver.

If there is more than one pallet 42 on the pallet sled 10, the CPU 93 takes a short side image of each of the pallets 42 on the pallet sled 10 and retrieves the previous images taken at the DC 32 of all of the pallets 42 on the pallet sled 10. If the CPU 93 does not know which short-side image corresponds to which pallet 42 that it is carrying, then the image of each pallet 42 taken by the camera 92 is compared the short-side images taken at the DC 32 of all of the pallets 42 that are currently on the pallet sled 42. For example, if there are two loaded pallets 42 on the pallet sled 10, the pallet sled 10 reads the RFID tags 94 on both loaded pallets 42 but it may not know which pallet 42 is which. Therefore the short-side image of each loaded pallet 42 on the pallet sled 10 would be compared to all four short-side images of the two pallets 42 taken at the DC 32. If the short-side image of at least one of the loaded pallets 42 on the pallet sled 10 does not sufficiently match one of those four images, then the CPU 93 generates a warning message for the driver.

If the pallet sled 10 weighs the loaded pallet 42, this information can also be used to validate the loaded pallet 42. The CPU 93 (or server 34) compares the weight from weight sensor 97 to an expected weight of the empty pallet 42 plus the expected weight of all the SKUs that should be loaded on the pallet 42. For example, because the specific pallet 42 is identified based upon the RFID tag 94 (or other pallet id), the CPU 93 can look up the list of SKUs that should be on that particular pallet 42 and the expected weights of those SKUs.

Alternatively, the CPU 93 (or server 34) can compare the weight from the weight sensor 97 to an actual weight of the loaded pallet 42 that was measured at the DC 32 after it was loaded. This verifies that nothing has changed (added or removed) since the pallet 42 was loaded and verified at the DC 32.

If the pallet sled 10 is carrying more than one loaded pallet 42, a similar weight analysis can be performed. For example, the total weight of the loaded pallets 42 can be compared to the total calculated weights of the specific identified pallets 42 on the pallet sled 10 (e.g. the expected weight of the empty pallets 42 plus the expected weights of each of all of the SKUs that should be loaded on the pallets 42) or compared to a total of the actual weights of the loaded pallets 42 as previously measured at the DC 32 after they were loaded.

If a discrepancy is detected, the CPU 93 indicates the discrepancy to the driver (either via an interface on the CPU 93 or via the driver's mobile device 50). There may only be a general indication of a discrepancy if the system does not have enough information (e.g. only a short side image), or the system may be able to indicate the specific discrepancy and how to remedy the discrepancy to the driver.

For example, the CPU 93 may indicate that the weight measured on the tines differs by more than a threshold from an expected (or previous) weight of the pallet(s) 42.

If a general discrepancy is indicated, the driver can then use the driver's mobile device 50 to take a plurality of images of the loaded pallet 42 (or possibly a single image from a corner). These images can be uploaded to the server 34 to be processed e.g. via machine learning to identify specific SKUs on the loaded pallet 42 and to identify a specific discrepancy for the driver to correct (e.g. one or more missing SKUs and/or extra SKUs).

The driver can correct the discrepancy by retrieving items 40 of the missing SKUs from the truck 38 or crediting the missing SKUs to the store account. Any SKUs detected that do not belong on the pallets 42 can be returned by the driver to the truck 38. On the store worker's mobile device (via an app), the store worker confirms the presence of the loaded pallet 42 and receives a list of SKUs associated with that pallet id from the server 34.

Asset Tracking

The pallet sled 10 can also assist in tracking the return of the pallets 42 and returnable packaging such as plastic beverage crates 98. The pallet sled 10 can count the number of crates 98 and the pallets 42 that are being returned to the truck 38 and report those numbers to the server 34. If the returnable packaging, such as plastic beverage crates 98, have rfid tags 96, the rfid reader 90 on the pallet sled 10 can count the number of crates 98 that are being returned to the truck 38. The camera 92 and/or weight sensor 97 can also estimate the type and quantity of returnable packaging and/or pallets 42 that is being returned. Over time, this can provide asset tracking information. For example, this enables the server 34 to determine if the number of pallets 42 and/or number of crates 98 delivered to a particular store 36 consistently exceeds the number of pallets 42 and/or number of crates 98 that are returned from that store 36, thus indicating that the store 36 is experiencing a high rate of asset loss for some reason, which can then be investigated and remedied.

Pallet Sled Tracking

The CPU 93 tracks the location of the pallet sled 10 via the GPS receiver 91 over time. The CPU 93 tracks when the pallet sled 10 lifts a pallet 42 (because the CPU 93 activates the actuator to lift the tines), the weight lifted by the pallet sled 10 each time, which pallet 42 is lifted by the pallet sled 10 (and when), and/or which pallet 42 is carried by the pallet sled 10 into which store 36 (and when). This information is transmitted to server 34.

The CPU 93 monitors and accumulates biometric data of the pallet sled 10, such as time in the truck 38, time walking from the truck 38 to the store 36, time for check-in, time for stocking shelves and/or, time for check out, time walking from store to truck. Time in the truck can be determined from the GPS receiver 91. The amount of time walking from the truck 38 to the store 36 and the path traveled by the pallet sled 10 can be determined from the GPS receiver 91 and/or the camera 92. Time for check-in can be determined as time after the pallet sled 10 is in the store 36 before pallet unloading begins, as determined by the camera 92 and/or the weight sensor 97 detecting removal of the items 40 and/or the actuator lowering the tines. Time for stocking shelves can be determined as time after the pallet sled 10 is in the store 36 after pallet unloading begins, as determined by the camera 92 and/or the weight sensor 97 detecting removal of the items 40, until pallet 42 is determined to be empty by the camera 92 and/or weight sensor 97. Time for check out can be determined to be time after the pallet 42 is empty until pallet sled 10 is moved out of the store 36, as determined by GPS receiver 91 and/or camera 92. The amount of time walking from the store 36 to the truck 38 and the path traveled by the pallet sled 10 can be determined by the GPS receiver 91 and/or camera 92.

If the amount of time spent at a particular store 36 is high compared to other stores or compared to previous deliveries to that store 36, the paths between the truck 38 and the store 36 can be viewed on a map and any obstacles (such as trucks or other vehicles) that were identified in the images can be superimposed on the map. If desired, the original images can be viewed by the user.

This data is all sent to the server 34 (FIG. 1) and compiled for the plurality of pallet sleds 10. With this data, the server 34 determines the time spent for each stop (each store) and for each route. The server 34 determines the time spent by customer and by franchise. The server 34 reconciles assets (pallets 42 and returnable packaging, such as crates 98), as explained above. The server 34 determines seasonality trends, performs drive and route comparisons, performs region metrics comparisons, and provides industry comparisons.

The CPU 93 collects data regarding usage of the pallet sled 10 from multiple sensors on the pallet sled 10, such as via the bus 80, such as one or more of the following: a sensor detecting lift cycles (how many times the pallet sled 10 has lifted a pallet 42) or the actuations of the lift actuator 82, or actuations as commanded by the CPU 93 (or a dedicated onboard CPU), the weight sensor 97 (how much weight is being lifted by the pallet sled 10 and how much weight is on the pallet sled 10 as it is being rolled a measured distance across parking lots and store floors), how much distance has the pallet sled 10 been rolled while empty and while loaded, average and extreme temperatures experienced by the pallet sled 10 during use. If the pallet sled 10 has expandable tines, the CPU 93 collects cycles of the expansion and retraction of the expandable tines over the bus 80, such as from a position sensor of the tines 14 or the one of the actuators 82 that is configured to expand and retract the tines. This collected data is sent to the server 34 for preventative and predictive maintenance analysis.

At the Store

At the store 36, the camera 92 on the pallet sled 10 records continuously (either video or sequential still images or some combination thereof) starting in the truck 38, as the driver loads the sled 10 with one or more pallets 42, as the driver moves the sled 10 loaded with pallets 42 from the truck 38 through the parking lot or alley and into the store 36 (FIG. 1).

As the pallet sled 10 enters the store 36 (FIG. 1), the camera 92 may continuously record images (again, video images and/or still images). The onboard CPU 93 and/or the server 34 (later) may analyze the images to detect obstacles (such as trucks or other vehicles blocking the entrance to the store 36 and/or blocking the most efficient route from the truck 38 to the store 36). The images are also analyzed to detect the entrance to the store 36 such that images and other data collected subsequent to the entrance can be marked as “in the store.”

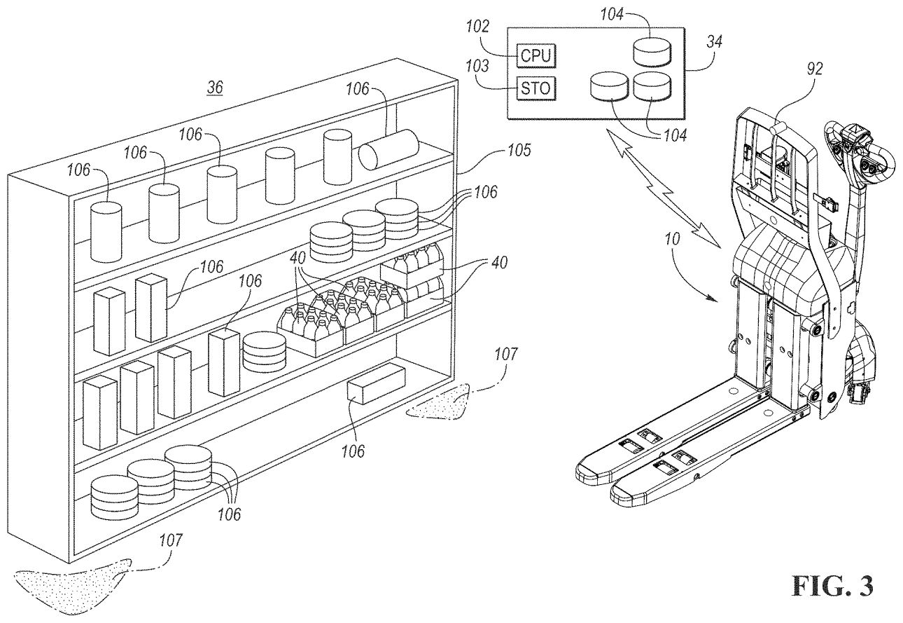

FIG. 3 shows the pallet sled 10 inside one of the stores 36. The camera 92 on the pallet sled 10 records continuously (either video or sequential still images or some combination thereof) as the pallet sled 10 is moved down the aisle(s) and/or to the cooler, as the driver unloads the pallets 42 from the sled 10, as the driver unloads items 40 from the pallets 42 and loads the shelves (if that is done), and as the driver returns with the sled 10 to the truck 38 (FIG. 1), optionally with empty pallets 42 and/or reusable containers.

In FIG. 3 the pallet sled 10 is being moved down the aisle adjacent shelves 105 in the store 36 (the pallet sled 10 would be loaded with one or more pallets 42 loaded with items 40—not shown). The aisle could be the general store aisle or could be an aisle in a cooler. Items 40 are on the shelves 105 as are other items 106. The aisle may have dirty areas 107, such as dirt, liquid spills, etc.

The pallet sled 10 may be in communication with the server 34 at all times, or alternatively may store the data (including video) locally and upload the data to the server 34, such as at the DC 32 (FIG. 1). The server 34 includes at least one processor 102 and appropriate electronic storage 103 storing computer programs which when executed by the processor 102 perform the functions described herein. The server 34 also includes electronic storage containing at least one machine learning model 104 (three shown). The machine learning models 104 are trained with images of example items 40, such that the SKUs of such items 40 can be identified by use of the machine learning models 104. One or more of the machine learning models 104 is also trained to perform other image analysis as described herein.

These images (video and/or still) are synced with time, date, and gps location data and sent to the server 34, either directly from the sled 10 via the communication circuit 95, via the driver's mobile device 50, or later via transfer at the DC 32 (e.g. Bluetooth or WiFi). The video or images may also be synced with other sensor information such as information from the accelerometer 101.

For example, if a hard brake or fall or impact is detected by the CPU 93 on the pallet sled 10 via analysis of signals from the accelerometer 101 (and the signals from the accelerometer 101 exceeding a threshold), the camera 92 can be triggered by the CPU 93 to take one or more images or a video for a period of time afterward (e.g. one minute). Or if the camera 92 is already recording continuous video or images, then the hard acceleration (from accelerometer 101) is synced with the video/images so that the video/images leading up to, during and after the hard acceleration can be evaluated later. Alternatively, the detection of the hard acceleration may be used to trigger retention of video and/or images for a period of time surrounding the hard acceleration that would have otherwise been discarded or overwritten.

Similarly, if the CPU 93 detects a fault or error on the bus 80, such as from the sensors or from the actuators 82, or a particular sensor value on the bus 80 (e.g. high temp) the camera 92 can be triggered by the CPU 93 to take one or more images or a video for a period of time afterward (e.g. one minute). Or if the camera 92 is already recording continuous video or images, then the fault, error, or sensor value is synced with the video/images so that the video/images leading up to, during and after the hard acceleration can be evaluated later. Alternatively, the detection of the fault, error or sensor value may be used to trigger retention of video and/or images for a period of time surrounding the hard acceleration that would have otherwise been discarded or overwritten.

The server 34 includes machine learning models 104 trained on one or more of the following:

a) the items 40 (SKUs) that may be delivered by the driver;

b) pathways, such as aisles, with and without obstacles, and with and without dirty areas 107;

c) general store shelves 105 with and without the items 40 and with and without other items 106 (e.g. other grocery items);

d) cooler shelves 105 with and without the items 40 and with and without other objects; and

e) parking lots and alleys with smooth pavement, with potholes or rough terrain, with and without obstacles such as debris.

The server 34, using the machine learning models 104, can then determine:

1) the SKUs of the items 40 are on the shelves 105 (on the stores shelves and the cooler and freezer shelves) and at least to some extent the quantity of the items 40 associated with each SKU;

2) conditions of the stores (cleanliness, organization, clutter, etc); and

3) conditions of the pathways to the store from the truck (e.g. is the store dirty or cluttered?).

The recorded footage from the camera 92 from the store 36 can be used in several ways:

1) document accidents for liability claims;

2) analyze items 40 on the shelves (via the machine learning models 104), such as determining inventory levels and how certain SKUs are being merchandized, determining whether the SKUS are being merchandized correctly, determining whether certain SKUs being allocated the amount of space that they should;

3) record pathways to fridge or cooler doors (simply documenting it for review by a human or also analyzing it via the machine learning models 104); and

4) record the environment around the sled 10 at the store 36.

This could indicate whether shelves/cooler cases were ready for product at the time of delivery and could indicate whether the driver needed to wait longer than usual for a store clerk to help them.

The camera 92 could also be used as part of a self-driving or semi-automated driving sled 10.

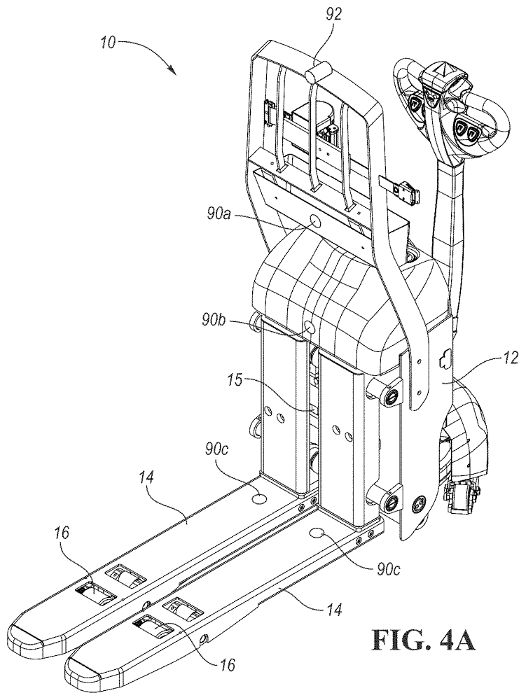

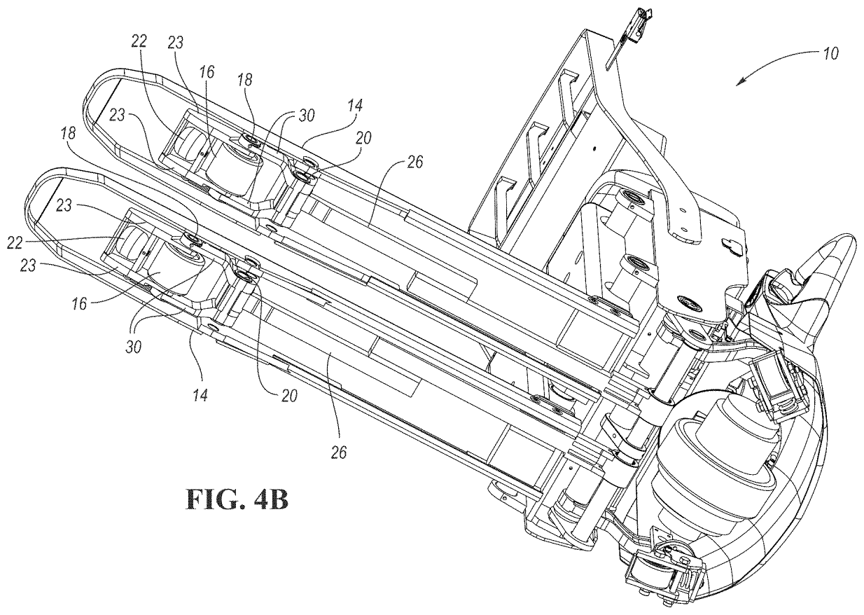

FIGS. 4A-8 show one possible configuration of the mechanical features of the pallet sled 10. Referring to FIG. 1, the pallet sled 10 includes a lift module or base 12 containing the lift mechanisms and the tine spacing actuators 15. The base 12 may also contain all of the hardware shown schematically in FIG. 2, most of which could be provided in a mobile device (such as smart phone or tablet). The base 12 is connected to a pair of fork tines 14. The base 12 can raise and lower the fork tines in a known manner, by leveraging the load wheels 16 supporting the tines 14, such as by hydraulics, pneumatics, electric motors, or via a manual actuator. The base 12 can also move the tines toward and away from one another with the tine spacing actuators 15, which could be hydraulics, pneumatics, electric motors driving a ball screw or a threaded rod, or via a manual actuator.

The pallet jack mechanism could be semi-electric, e.g. electric drive system and manual lifting (via pumping the tiller arm) or full-electric, e.g. electric drive system and electric lifting/lowering. In this example, the lift is semi- or full-electric, so battery power exists on the equipment to drive the actuators whether it be an electric hydraulic pump or electric motor. Other power sources could be provided, including manual.

The pallet sled 10 may provide a first mechanism for facilitating the adjustment of the tine spacing without dragging the load wheels 16.

FIG. 4A shows the RFID reader 90 in several optional locations (RFID readers 90a-c—specifically referring to the location of the RFID reader antenna). First, the RFID reader 90a could be mounted in the backrest of the pallet sled 10. Alternatively, or additionally, the RFID reader 90b could be mounted within the base 12. Alternatively, or additionally, the RFID reader 90c could be mounted in one or both of the tines 14, which might enable distinguishing which pallet is on which tine 14.

FIG. 4B is a perspective view of the underside of the tines 14 of FIG. 1. Each tine 14 includes a load wheel 16 which is rotatable on an axis 18 perpendicular to the long axis of the tine 14. The load wheel axis 18 is mounted at the end of a pair of arms 30 which are pivotable about an axis 20 fixed to the tine 14. The axis 20 is spaced rearwardly of the axis 18, and also perpendicular to the long axis of the tine 14. A side wheel 22 is mounted to arms 23 extending forwardly of the load wheel 16 and is oriented in a direction such that its axis is transverse to the load wheel axis 18. The arms 23 are pivotable about the axis 18 (but could alternatively pivot about an axis parallel to that load wheel axis 18) in a vertical plane parallel to the long axis of the tine 14.

As explained below, the side wheel 22 can facilitate lateral motion of the tine 14. A push rod 26 within each tine 14 pivots the arms 30 to deploy and retract the load wheels 16, in a known manner (e.g. via a lift actuator coupled to the push rods 26, such as a hydraulic cylinder or electric motor).

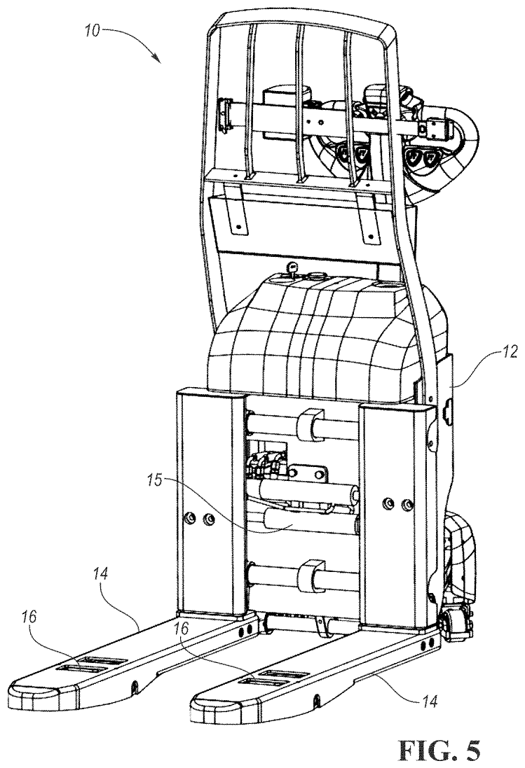

In FIGS. 4A and 4B, the tines 14 of the pallet sled 10 are spaced closed to one another. In FIG. 5, the tines 14 are spaced further apart. The actuators 15 for moving the tines 14 toward and away from each other are shown on the base 12. As will be explained below, the side wheels 22 permit the tines 14 to be moved toward and away from each other without dragging the load wheels 16 parallel to their axes 18, which could cause damage to the load wheels 16 and/or the floor.

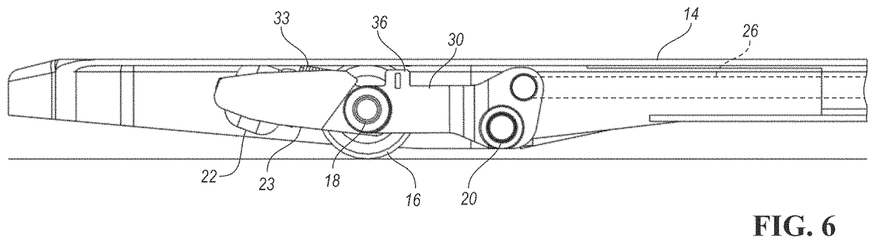

FIG. 6 shows a side view of the tine 14 (without the base 12, for simplicity) and with part of the tine 14 broken away for illustration. The tine 14 is in the low position with the load wheel 16 retracted into the tine 14 as much as possible. In this position, the tines 14 are closest to the floor and can be slid under a pallet. The load wheel 16 is rotatable on the axis 18 at the end of the arm 30 which pivots about an axis 20 that is fixed to the tine 14. The push rod 26 is pivotably secured to a rearward portion of the arm 30 at a pivot point that is rearward and upward of the axis 20. In a generally known manner, the push rod 26 can, by forward motion, cause the load wheel 16 to deploy downward and lift the tine 14. By rearward motion, the push rod 26 causes the load wheel 16 to retract upward into the tine 14, lowering the tine 14 relative to the floor. The arms 30 each include a stop 36 projecting upward from a point rearward of the load wheel axis 18.

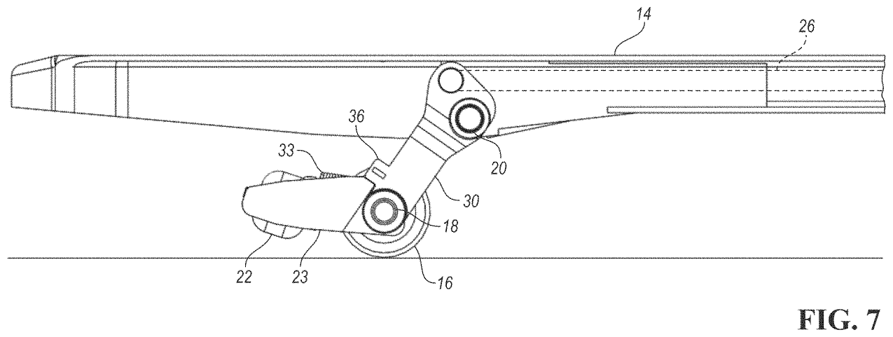

Still referring to FIG. 6, stretching the springs 33 permits the load wheels 16 to move closer to the underside of the tines 14 by permitting rotation of the arms 23 downward away from the arms 30 to the position where both the arms 23 and the arms 30 are substantially horizontal. In FIG. 7, the springs 33 are contracted.

FIG. 7 shows the tines 14 in a lifted or high position, such as would be used to lift a pallet off a floor and move the pallet. The arms 30 are pivoted downward, thereby moving the load wheels 16 away from the tines 14, causing the tines 14 to move away from the floor, with the load wheels 16 on the floor. The side wheel 22 is rotatable on an axis almost parallel to arm 23. A spring 33 biases the arm 23 upward rotationally toward the arm 30 and toward the tine 14. The pushrod 26 is moved forward to a mid position, such that the arms 30 pivot downward about axis 20 until the load wheel 16 is moved to a lift position away from the tine 14 but the side wheel 22 is still spaced above the floor. As the arms 30 pivot downward away from the underside of the tine 14, the spring 33 is able to pull the arms 23 about the axis 18 upward toward the arms 30 (and toward the tine 14) until the arms 23 contact the stops 36 on the arms 30. In this manner, the springs 33 hold the side wheels 22 off the floor in this high position.

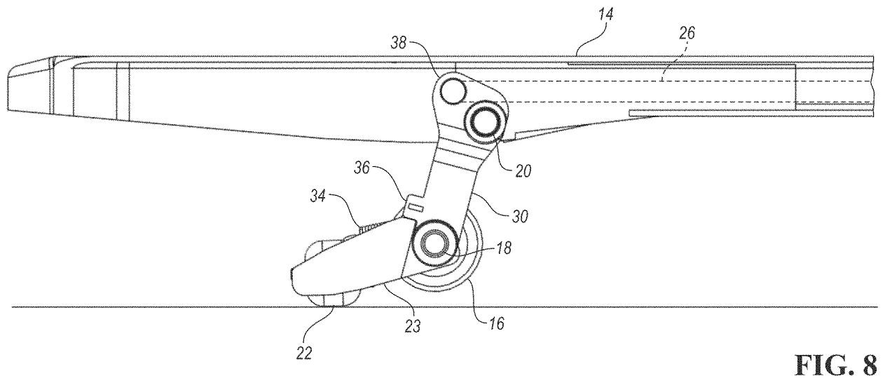

FIG. 8 shows the tines 14 of the pallet sled 10 with the load wheels 16 and side wheels 22 moved to the side-shifting position, i.e. the side wheels 22 are in contact with the floor and the load wheels 16 are lifted off the floor. The push rod 26 has been moved forward to its furthest forward position, rotating the arms 30 downward to a maximum degree. This also rotates the arms 23 further downward until the side wheels 22 contact the floor, then lifting the load wheel 16 off the floor, and lifting the tines 14 even a little higher (this would not be done while the tines 14 are loaded). Each side wheel 22 provides a support surface configured to selectively be the lowermost surface of the tine to facilitate lateral displacement of the first tine.

The tines 14 can then be moved back toward one another as shown in FIGS. 4A and 4B. The tines 14 would roll on the side wheels 22. With the load wheels 16 off the floor, movement of the tines 14 laterally does not damage the load wheels 16 or the floor. In this side-shifting position, the tines 14 can be moved laterally toward and away from one another. With the tines 14 closely-spaced near one another or spaced further apart from one another, the load wheels 16 and tines 14 can be moved back and forth between the lift position, the low position, and the side-shifting position.

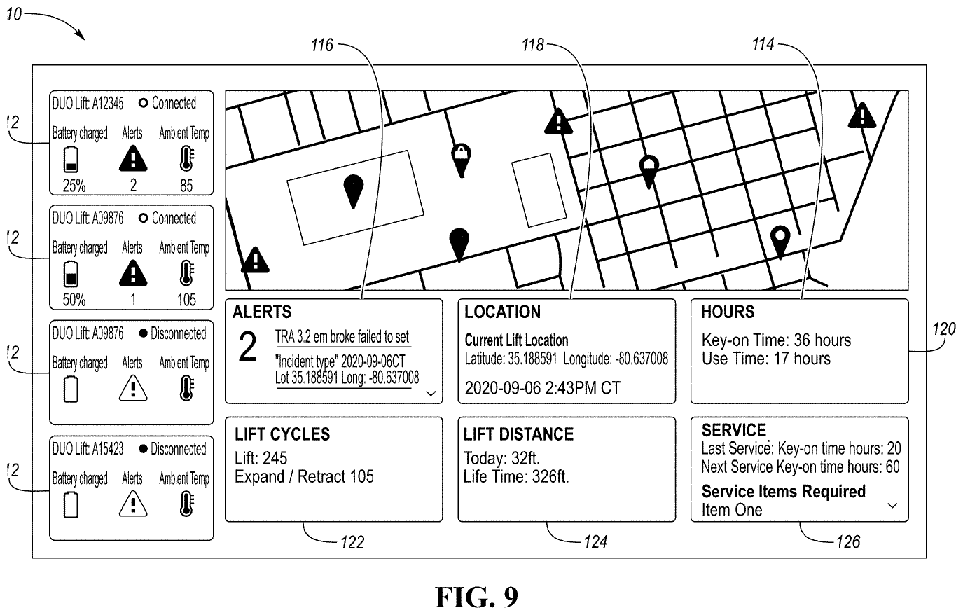

FIG. 9 shows an example display screen 110 from the server 34 of FIG. 1 (such as a workstation or mobile device remotely accessing data on the server 34). The display screen 110 will only show information regarding pallet sleds 10 to which the user has permission. For example, a site manager will only have access to their pallet sleds 10, while a regional manager will have access to all of the pallet sleds 10 in the area.

A small status window 112 for each pallet sled 10 (FIG. 1) is displayed on the screen 110. Each status window 112 gives a summary of the status of the associated pallet sled 10, which is identified in the window 112, including for example, whether the pallet sled 10 is currently connected to the server 34 (e.g. via communication circuit 95, FIG. 2), the current charging level of the battery in the pallet sled 10, whether there are any alerts associated with the pallet sled 10, and the ambient temperature around the pallet sled 10. The battery for powering the pallet sled 10 may only operate (charge or discharge) within a certain temperature range. Therefore, if the user sees a temperature outside that range, the battery may need to be removed for charging in a temperature-controlled environment.

A map 114 shows a current location of the pallet sleds 10, including whether there are associated alerts.

If the user selected one of the windows 112, the rest of the display shows more information. An alert window 116 is displayed for the selected pallet sled 10 giving more detail about the alerts, such as errors, failures, necessary maintenance, or other incidents. Location window 118 shows a specific location of the pallet sled 10, such as the lat/long and the date/time that the lat/long was received by the server 34. A time usage window 120 shows the elapsed time (e.g. hours) that the pallet sled 10 has been in an “on” mode and actual “use” time.

A cycle window 122 displays the number of lift cycles and (if applicable) the number of expansion/retraction cycles. A lift distance window 124 displays the total lift distance by the tines of the pallet sled 10 both in terms of a total for the current day and lifetime total. A service window 126 displays the key-on time since the last service on the pallet sled 10 and the key-on time until the next service should be performed. This time until next service could be based upon actual usage of the pallet sled 10, i.e. it could be based upon key-on time, use time, lift cycles, expansion/retraction cycles, and/or lift distance, or any combination or weighted combination of these. In the service window 126 specific service items may also be specified based upon reports from sensors onboard the pallet sled 10 and/or directly from the user.

Expanding the service window 126 (expanded window not shown) could provide a specific service alert regarding that pallet sled 10. For example, there may be a message describing the problem with the pallet sled 10 along with a recommendation for troubleshooting and/or repairing the problem. The display may provide a link that will order the necessary parts of the pallet sled 10 (based upon the detected error) and the specific steps needed to diagnose the problem further and/or to make the repair, such as how to install a replacement part. The service window 126 could alternatively be displayed by the CPU 93 on the pallet sled 10 itself, or on the mobile device 50.

In accordance with the provisions of the patent statutes and jurisprudence, exemplary configurations described above are considered to represent preferred embodiments of the inventions. However, it should be noted that the inventions can be practiced otherwise than as specifically illustrated and described without departing from its spirit or scope. Alphanumeric identifiers on method steps are solely for ease in reference in dependent claims and such identifiers by themselves do not signify a required sequence of performance, unless otherwise explicitly specified.

What is claimed is:

1. A delivery system comprising:
a pallet sled including a pair of tines extending forward from a base, and a load wheel supporting each of the pair of tines, the load wheels each configured to move away from the respective tine to lift the respective tine upward relative to a floor;
a camera on the pallet sled; and
at least one computer configured to receive images from the camera, the at least one computer programmed to analyze the images received from the camera.

2. The delivery system of claim 1 wherein the at least one computer is programmed to identify SKUs of products in the images received from the camera.

3. The delivery system of claim 2 wherein the at least one computer is programmed to determine an inventory level of the products in the images.

4. The delivery system of claim 3 wherein the at least one computer is programmed to determine the inventory level of the products on shelves in the images.

5. The delivery system of claim 1 wherein the at least one computer is programmed to analyze pathways traveled by the pallet sled in the images received from the camera.

6. The delivery system of claim 1 wherein the at least one computer is programmed to determine a condition of a store based upon the images received from the camera.

7. The delivery system of claim 6 wherein the at least one computer is programmed to determine a cleanliness level of the store based upon the images received from the camera.

8. A pallet sled comprising:
a base;
a pair of tines extending forward from the base;
a load wheel supporting each of the pair of tines, the load wheels each configured to move away from the respective tine to lift the respective tine upward relative to a support surface on which the load wheel is supported;
an accelerometer mounted to the pallet sled;
a camera mounted to the pallet sled; and
at least one processor programmed to record signals from the accelerometer and images from the camera.

9. The pallet sled of claim 8 wherein the at least one processor is programmed to record images from the camera based upon the signals from the accelerometer.

10. The pallet sled of claim 9 wherein the at least one processor is programmed to record images from the camera based upon the signals from the accelerometer exceeding a threshold.

11. The pallet sled of claim 8 wherein the at least one processor is programmed to synchronize images from the camera with the signals from the accelerometer.

12. The pallet sled of claim 8 wherein the images are video images.

13. The pallet sled of claim 8 further including an RFID reader antenna in at least one of the pair of tines.

14. A method for monitoring operation of a pallet sled including:
a) receiving images from a pallet sled while the pallet sled is delivery items to a store; and
b) analyzing with at least one processor the images received in step a).

15. The method of claim 14 wherein step b) further includes identifying SKUs of products in the images received in step a).

16. The method of claim 15 further including determining an inventory level of the products in the images.

17. The method of claim 14 further including determining an inventory level of products on shelves in the images.

18. The method of claim 14 wherein step b) further includes analyzing pathways traveled by the pallet sled in the images.

19. The method of claim 14 further including determining a condition of a store based upon step b).

20. The method of claim 14 wherein the at least one processor uses at least one machine learning model to perform step b).

21. A pallet sled comprising:
a base;
a pair of tines extending forward from the base;
an RFID reader antenna mounted in at least one of the pair of tines; and
a load wheel supporting each of the pair of tines, the load wheels each configured to move away from the respective tine to lift the respective tine upward relative to a support surface on which the load wheel is supported.
